(19) United States
(12) Patent Application Publication
(10) Pub. No.: US 2008/0226088 A1
(43) Pub. Date: Sep. 18, 2008

(54) Audio Transducer System

(75) Inventors: Ronaldus Maria Aarts, Eindhoven (NL); Okke Ouweltjes, Eindhoven (NL); Joris Adelbert Maria Nieuwendijk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/067,301

(22) PCT Filed: Sep. 5, 2006
(86) PCT No.: PCT/IB06/53107

§ 371 Date: Mar. 19, 2008

(30) Foreign Application Priority Data
Sep. 20, 2005 (EP) 05108634.6

(51) Int. Cl. H04R 29/00

(52) U.S. Cl. 381/59

(57) ABSTRACT

A device is arranged for driving a transducer unit (20) comprising at least one transducer (21) accommodated in an enclosure (22). The device comprises mapping means for mapping input signal components having a first audio frequency range onto a second audio frequency range. The second audio frequency range is narrower than the first audio frequency range, and the second frequency range contains the Helmholtz frequency of the transducer unit (20). A transducer unit (20) for use with the device is optimized for operating in a narrow frequency range at or near the Helmholtz frequency (f_{H}).

The present invention relates to efficient audio transducers. More in particular, the present invention relates to a device and method for driving a transducer at a certain frequency, and to a transducer designed to be driven at a certain frequency.

It is well known that audio transducers, such as loudspeakers, have a limited frequency range in which they can faithfully render sound at a certain minimum sound level. High fidelity audio systems typically have relatively small transducers (tweeters) for reproducing the high frequency range, and relatively large transducers (woofers) for reproducing the low frequency range. The transducers required to reproduce the lowest audible frequencies (approximately 20-100 Hz) at a suitable sound level take up a substantial amount of space. Consumers, however, often prefer compact audio sets which necessarily have small transducers.

It has been suggested to solve this problem by using psycho-acoustic phenomena such as “virtual pitch”. By creating harmonics of low-frequency signal components it is possible to suggest the presence of such signal components without actually reproducing these components. However, this solution is no substitute for actually producing low-frequency (“bass”) signal components.

International Patent Application WO 2005/027569 (Philips) discloses a device for producing a driving signal for a transducer, such as a loudspeaker. The driving signal has a frequency substantially equal to a resonance frequency of the transducer. By driving the transducer at a resonance frequency, a very efficient sound reproduction at low frequencies can be achieved. It has been found, however, that to achieve high sound levels at certain resonance frequencies, the displacement of the transducer becomes very large, in some cases even prohibitively large.

It is an object of the present invention to provide a device and method for driving a transducer, arranged for providing high sound levels using a relatively small transducer and relatively small transducer displacements.

Accordingly, the present invention provides a device for driving a transducer unit comprising at least one transducer and an enclosure in which the at least one transducer is accommodated, the device comprising mapping means for mapping input signal components from a first audio frequency range onto a second audio frequency range,

wherein the second audio frequency range is narrower than the first audio frequency range, and wherein the second frequency range contains the Helmholtz frequency of the transducer unit.

By mapping a first frequency range onto a second, narrower frequency range, the frequency components of the first frequency range can be reproduced at frequencies where the transducer is most efficient.

By driving the transducer unit at its Helmholtz frequency, the transducer displacement (the cone displacement in the case of loudspeakers) is minimal while the sound level is high. It is noted that the Helmholtz frequency referred to here is the “anti-resonance” frequency of the transducer when accommodated in an enclosure, and that the dimensions and features of the enclosure, together with the transducer characteristics, determine the Helmholtz frequency.

It is noted that United States Patent Application US 2004/0028246 discloses a loudspeaker device including an acoustic pipe coupled to an acoustic chamber in which a loudspeaker is mounted. The pipe and the chamber constitute a Helmholtz resonator. However, this known device is designed to provide a continuous frequency band from the Helmholtz resonant frequency to the resonant frequency of the acoustic pipe, while the present invention provides a transducer unit designed to be driven in a relatively narrow frequency band which includes the Helmholtz frequency.

It is preferred that the narrow frequency range extends within 5% of the Helmholtz frequency, more preferably within 2%. That is, the second frequency range extends from 95% to 105% of the Helmholtz frequency, but preferably only from 98% to 102% of the Helmholtz frequency.

In a preferred embodiment of the driving device of the present invention, the mapping means comprise:
a detection unit for detecting first signal components in the first audio frequency range,
a generator unit for generating second signal components in the second audio frequency range, and
amplitude control means for controlling the amplitude of the second signal components in dependence of the amplitude of the first signal components. Such a driving device allows an efficient mapping of the first frequency range onto the second frequency range.

The present invention also provides a transducer unit for use with the device defined above, the transducer unit comprising at least one transducer and an enclosure in which the at least one transducer is mounted, the enclosure comprising an open-ended tube. It is noted that the tube used in the present invention has at least one opening at one end, while the particular shape of the opening(s) and the particular shape of the tube are not essential. Although the tube is preferred to have a constant diameter, conical tubes may also be used.

In a preferred embodiment of the invention, there is a well-defined relationship between the volume of the transducer unit and other properties. More in particular, the enclosure preferably defines a volume V₁ between the transducer and the tube which volume at least approximately satisfies the equation:

$${V}_{1} = \frac{c \cdot S}{2 π \cdot {f}_{w}} \cdot \frac{1 - η T}{η + T}$$

where c is the sound velocity in air, S is the inner cross-sectional surface of the tube, f_{w} is the central frequency of the second audio frequency range (that is, the operating frequency of the transducer unit, which operating frequency is approximately equal to its Helmholtz frequency), η is given by η≈0.85·2π·f_{w}·r/c, r is the inner radius of the tube, T is given by T=tan(2π·L·f_{w}/c), and L is the length of the tube. In this way, a very efficient transducer unit may be achieved.

In a further preferred embodiment, there is also a well-defined relationship between the force factor Bl and other properties. More in particular, the transducer preferably has a force factor Bl which at least approximately satisfies the equation:

$$Bl = \sqrt{{R}_{E}} \cdot {\{ \begin{matrix}{[ {R}_{M} + \frac{{( S \cdot ρ \cdot c )}^{2}}{{R}_{p}} \cdot \frac{{( T + η )}^{2}}{{T}^{2} + 1} ]}^{2} + \\ {( 2 π \cdot m \cdot {f}_{0} )}^{2} \cdot {[ \frac{{f}_{H}}{{f}_{0}} - \frac{{f}_{0}}{{f}_{H}} ]}^{2}\end{matrix} \}}^{1 / 4}$$

where R_{E} is the electrical resistance of the transducer, R_{M} is the mechanical resistance of the transducer, S is the effective radiating surface of the transducer, ρ is the density of air, c is the sound velocity in air, T is given by T=tan(2π·L·f_{H}/c), L is the length of the tube, η is given by η≈0.85·2π·f_{H}/c, m is the moving mass of the transducer, f_{H} is the Helmholtz frequency of the transducer unit, and f₀ is the resonance frequency of the transducer in the absence of an enclosure extending between the transducer and the open air. If the transducer unit fulfils this requirement, the efficiency is further enhanced.

In an alternative embodiment, the enclosure defines an additional volume V₂, which additional volume is substantially closed off, the volumes V₁ and V₂ preferably being located at opposite sides of the transducer. It is noted that a small leak may be present to equalize the pressure in the volume V₂, and that the volumes V₁ and V₂ may be acoustically coupled by a further tube instead of being located at opposite sides of the transducer.

Advantageously, any edges of the enclosure or of the associated tube are substantially rounded. This prevents any efficiency loss. In addition, it is preferred that substantially no damping material is present. Furthermore, the open end of the tube may advantageously be provided with a flange.

The present invention also provides a transducer unit which further comprises a driving device as defined above.

The present invention further provides an audio system, comprising an audio amplifier, at least one transducer and at least one device as defined above, the audio system preferably further comprising a sound source.

The present invention also provides a method of driving a transducer unit comprising at least one transducer accommodated in an enclosure provided with an open-ended tube, the method comprising the step of mapping an input signal onto a narrow frequency range containing the Helmholtz frequency of the transducer unit. Preferably, the narrow frequency range extends within 5% of the Helmholtz frequency, preferably within 2%.

The present invention additionally provides a computer program product for carrying out the method as defined above. A computer program product may comprise a set of computer executable instructions stored on a data carrier, such as a CD or a DVD. The set of computer executable instructions, which allow a programmable computer to carry out the method as defined above, may also be available for downloading from a remote server, for example via the Internet.

The present invention will further be explained below with reference to exemplary embodiments illustrated in the accompanying drawings, in which:

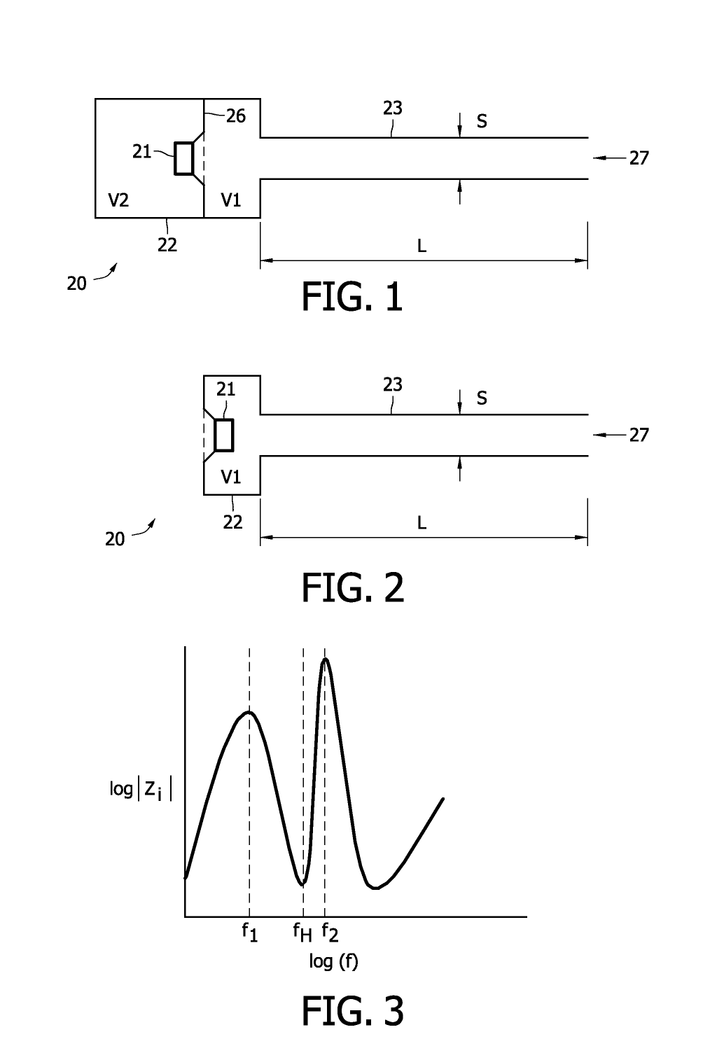

FIG. 1 schematically shows a first embodiment of a transducer unit according to the present invention.

FIG. 2 schematically shows a second embodiment of a transducer unit according to the present invention.

FIG. 3 schematically shows the electrical impedance of a transducer as a function of the frequency.

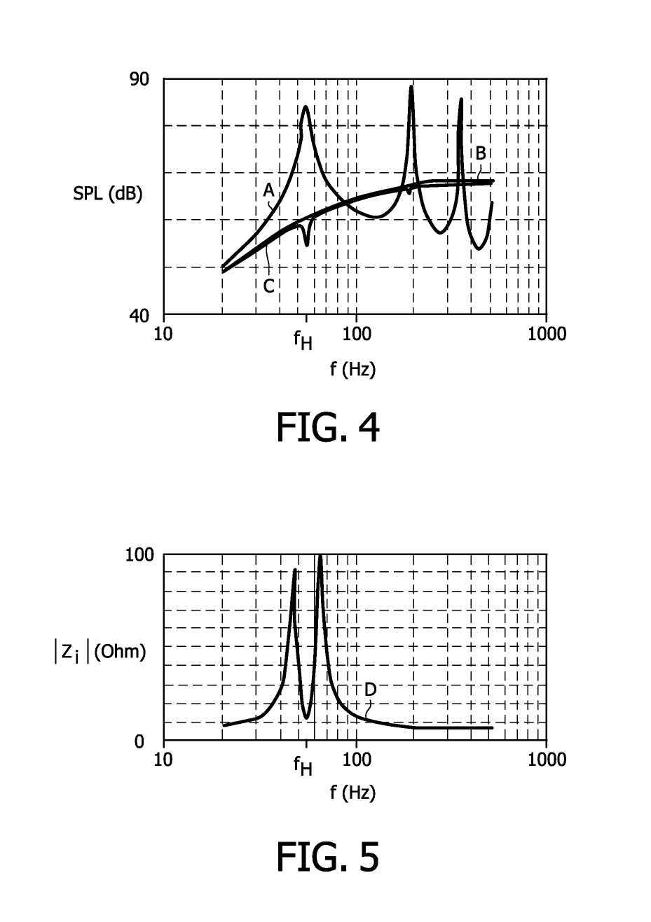

FIG. 4 schematically shows the sound pressure level of a transducer unit as a function of the frequency of the input signal.

FIG. 5 schematically shows the electrical input impedance of the transducer unit of FIG. 4 as a function of the frequency.

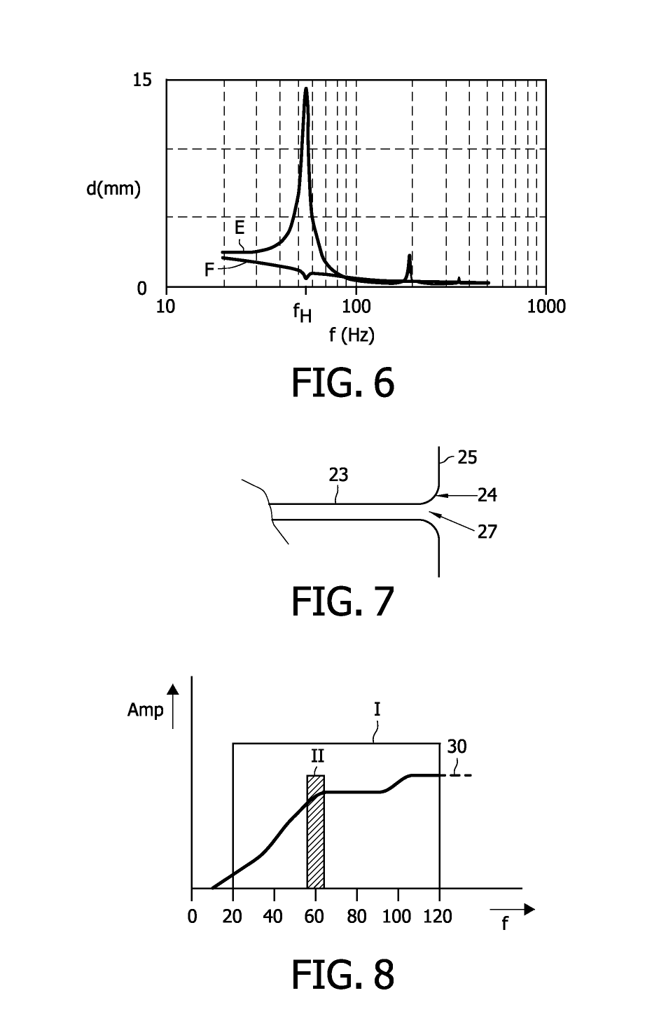

FIG. 6 schematically shows the cone displacement of the transducer unit of FIG. 4 as a function of the frequency.

FIG. 7 schematically shows the end of a tube as preferably used in a transducer unit of the present invention.

FIG. 8 schematically shows a first and a second frequency range in accordance with the present invention.

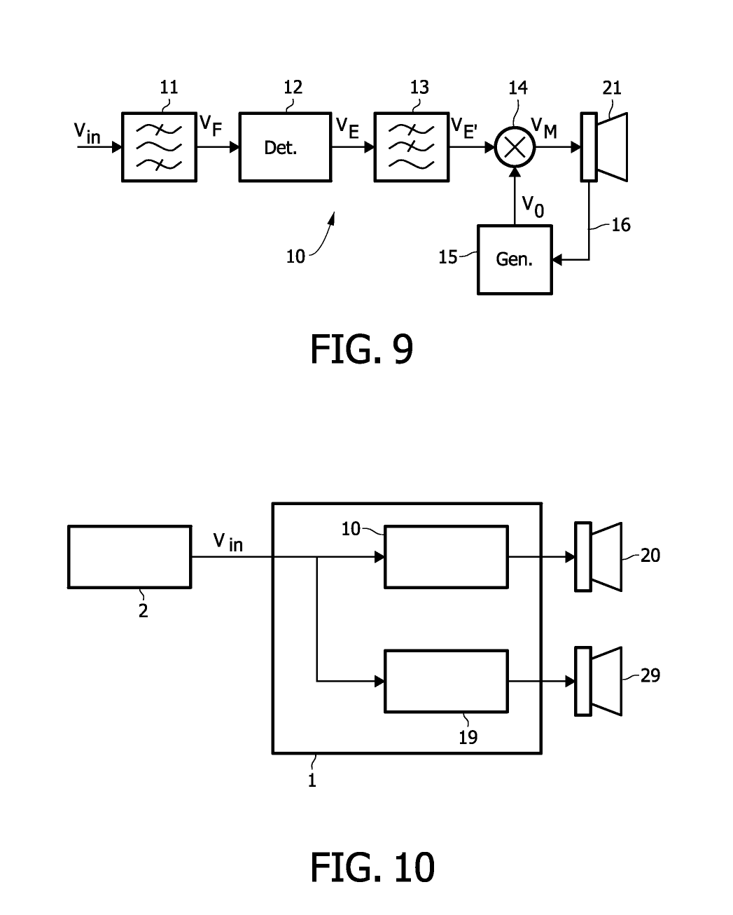

FIG. 9 schematically shows a device for driving a transducer in accordance with the present invention.

FIG. 10 schematically shows an audio system in accordance with the present invention.

The transducer unit 20 shown merely by way of non-limiting example in FIG. 1 comprises an enclosure 22 in which a transducer 21, such as a loudspeaker, is mounted. In the embodiment of FIG. 1, the enclosure 22 comprises two chambers which define a first volume V₁ and a second volume V₂ respectively, as well as a tube 23. The volumes V₁ and V₂ are divided by a partition 26 which supports the transducer 21. The first volume V₁ is in open communication with the tube 23, while the second volume V₂ is closed. In the embodiment shown the tube 23, which forms an integral part of the enclosure 22, does not project into any chamber, while the transducer faces the tube 23. It will be understood that other arrangements are possible, for example an arrangement in which the transducer 21 faces away from the tube 23.

The tube 23, which has an open end 27, has a length L and an internal cross-sectional surface area S which are chosen to match the Helmholtz frequency of the transducer, as will be explained later in more detail. The surface area S defines the effective radiating surface of the transducer 21. It is noted that the embodiments shown are not necessarily rendered to scale.

In the alternative embodiment of FIG. 2, the enclosure 22 has only a single chamber defining a single volume V₁. In addition, the front of the transducer (typically, the cone of the loudspeaker) 21 faces outwards, away from the tube 23. However, the transducer may also face towards the tube 23.

In both embodiments shown, no damping material is present in the enclosure, and the tube 23 is relatively long while the (first) volume V₁ is relatively small. In some embodiments, however, small amounts of damping material may be present, and the relative dimensions of the tube 23 and the volume V₁ may differ from those shown.

As mentioned above, the dimensions of the enclosure 22 are chosen such that the operating frequency f_{w} of the transducer is approximately equal to the Helmholtz frequency f_{H} of the transducer unit 20. Expressed mathematically:

f_{w}≈f_{H} (1)

It is preferred that the deviation from equality is less than 5%.

The Helmholtz frequency is illustrated in FIG. 3, where the electrical impedance Zᵢ of the transducer (21 in FIGS. 1 and 2) is shown as a function of the frequency f (both on a logarithmic scale). As can be seen, the electrical impedance reaches a maximum at a first resonance frequency f₁ and a second resonance frequency f₂. In between these resonance frequencies f₁ and f₂, the electrical impedance Zᵢ reaches a minimum at a frequency f_{H}. This frequency f_{H} is the Helmholtz frequency of the transducer unit: the frequency at which the so-called anti-resonance occurs in the transducer unit 20, resulting in a (local) minimum displacement of the transducer 21.

The electrical impedance may reach further maxima at further resonance frequencies, but these are not shown in FIG. 3 for the sake of clarity of the illustration.

It is noted that the Helmholtz frequency is, in the present invention, approximately equal to a resonance frequency of the transducer:

0.4·f_{H}<f₀<2.5·f_{H} (2)

where f_{H} is the Helmholtz frequency of the transducer unit 20 and f₀ is the resonance frequency of the transducer 21 in the absence of the volume V₁ and the tube 23 (in the embodiment of FIG. 1, this is the resonance frequency when the volume V₂ is present). In Prior Art arrangements, the resonance frequency f₀ typically coincides with the Helmholtz frequency f_{H}. In the arrangements of the present invention, the resonance frequency f₀ and the Helmholtz frequency f_{H} can differ considerably.

It is a feature of the present invention that the working frequency of the transducer unit 20 is approximately equal to its Helmholtz frequency, as expressed in equation (1) above. According to another aspect of the present invention, certain conditions are imposed upon the dimensions of the enclosure 22 and tube 23 to satisfy equation (1). Expressed mathematically, the first volume V₁, which is located between the transducer 21 and the tube 23, should at least approximately comply with:

$${V}_{1} = \frac{c \cdot S}{2 π \cdot {f}_{w}} \cdot \frac{1 - η T}{η + T} \qquad ( 3 )$$

In equation (3):

c is the sound velocity in air,

S is the inner cross-sectional surface of the tube 23,

f_{w} is the operating frequency of the transducer unit 20,

η is a quantity given by η≈0.85·2π·f_{w}·r/c,

r is the inner radius of the tube 23,

T is a quantity given by T=tan(2π·L·f_{w}/c), and

L is the length of the tube 23.

As will be discussed later with reference to FIGS. 8 and 9, the operating frequency f_{w} is approximately equal to the central frequency of the second audio frequency range (II in FIG. 9) onto which a first frequency range is mapped.

When equation (3) is satisfied, or at least approximately satisfied, equation (1) is satisfied as well and a very efficient sound reproduction is achieved. The efficiency can even be further improved if the force factor Bl of the transducer at least approximately satisfies the equation:

$$Bl = \sqrt{{R}_{E}} \cdot {\{ \begin{matrix}{[ {R}_{M} + \frac{{( S \cdot ρ \cdot c )}^{2}}{{R}_{p}} \cdot \frac{{( T + η )}^{2}}{{T}^{2} + 1} ]}^{2} + \\ {( 2 π \cdot m \cdot {f}_{0} )}^{2} \cdot {[ \frac{{f}_{H}}{{f}_{0}} - \frac{{f}_{0}}{{f}_{H}} ]}^{2}\end{matrix} \}}^{1 / 4} \qquad ( 4 )$$

In equation (4):

R_{E} is the electrical resistance of the transducer 21,

R_{M} is the mechanical resistance of the transducer,

Rₚ is the mechanical resistance of the tube 23,

S is the inner cross-sectional surface of the tube 23.

ρ is the density of air,

c is the sound velocity in air,

T is a quantity given by T=tan(2π·L·f_{H}/c),

f_{H} is the Helmholtz frequency of the transducer unit,

L is the length of the tube 23,

η is a quantity given by η≈0.85·2π·f_{H}/c,

m is the moving mass of the transducer, and

f₀ is the resonance frequency of the transducer, in the absence of an enclosure extending between the transducer and the open air, as mentioned above.

Lengths are expressed in meters (m), areas in square meters (m²), volumes in cubic meters (m³), velocities in meters per second (m/s) and frequencies in hertz (Hz). Electrical resistances are expressed in ohm (i), mechanical resistances in newton-seconds per meter (Ns/m), while the force factor Bl is expressed in newton per ampere (N/A).

It is noted that the force factor Bl is a quantity well known to those skilled in the Art. This force factor is the product of the flux density B of the magnetic field in the air gap of a loudspeaker and the effective length l of its voice coil wire.

The electrical resistance R_{E} of the transducer 21 is equal to the DC resistance (measured in Q) of the loudspeaker coil, while the mechanical resistance R_{M} (measured in Ns/m) is caused by the cone suspension of the loudspeaker (or its equivalent in case another type of transducer is used). The mechanical resistance Rₚ (measured in Ns/m) is the total mechanical resistance of the tube 23, including radiation resistance, seen as a lumped parameter at the end 27 of the tube 23.

The effective radiating surface S of the transducer is typically equal to the cross-sectional (inner) surface area of the tube 23. The length L of the tube 23 preferably ranges from λ₀/8 to λ₀/4, where λ₀ is the wavelength corresponding with the resonance frequency f₀ mentioned above: λ₀=c/f₀, where c is the sound velocity in air.

If equation (4) is satisfied exactly, an optimum Blₒₚₜ results. It has been found that satisfactory results can still be obtained if:

0.5·Blₒₚₜ<Bl<2·Blₒₚₜ (5)

It is preferred, however, that Bl lies within the range:

0.75·Blₒₚₜ<Bl<1.5·Blₒₚₜ (6)

In other words, the force factor Bl should preferably be larger than 34 of the value given by equation (4) above, and smaller than 1½ times said value.

The effects of the measures of the present invention will be further explained with reference to FIGS. 4, 5 and 6. FIG. 4 shows the sound pressure level (SPL) of a transducer unit (20 in FIGS. 1 and 2) as a function of the frequency f. The SPL is shown in deciBels (dB), the frequency has a logarithmic scale. Graph A shows the SPL of the transducer unit (that is, the transducer mounted in an enclosure having a tube, as illustrated in FIGS. 1 and 2), while Graph B shows the SPL of a reference chamber with a single closed volume equal to the sum of V₁, V₂ and the internal volume of the tube 23, the same transducer (21 in FIGS. 1 and 2) being mounted in the reference chamber. Graph C shows the SPL of the transducer mounted in an infinite baffle and having the same displacement as a function of the frequency as in the transducer unit (20 in FIGS. 1 and 2). It is noted that graph C is obtained by driving the transducer (in dependence of the frequency) in such a way that the same displacement is obtained as would be obtained with the enclosure provided with a tube.

The sound pressure level (SPL) of the transducer (graph C) drops sharply at approximately 55 Hz, the Helmholtz frequency f_{H} of the transducer unit as its cone displacement decreases. When mounted in a properly designed enclosure, however, the sound pressure level sharply increases at this frequency. In other words, at this frequency a very large SPL can be obtained, as illustrated in graph A.

The corresponding absolute value |Zᵢ| of the transducer impedance Zᵢ is illustrated in FIG. 5, where |Zᵢ| is shown to have two peaks and a trough in between these peaks. The trough occurs at the Helmholtz frequency f_{H}.

The corresponding cone displacement of the transducer is illustrated in FIG. 6. The cone displacement d (measured in millimeters) is shown as a function of the frequency f. Graph E shows the displacement necessary for a transducer mounted on a baffle to obtain, at the frequency f_{H} of (in the present example) approximately 55 Hz, the same sound pressure level (SPL) as in graph A in FIG. 4 (approximately 84 dB). According to graph E, the required cone displacement would be about 14 mm, which requires a relatively expensive transducer. In the arrangement of the present invention, however, which is tuned to the Helmholtz frequency, the required cone displacement is less than 2 mm, as illustrated by graph F. In other words, the present invention allows to obtain a high sound pressure level at a minimal cone displacement.

According to a still further aspect of the present invention, the enclosure 22 and/or the tube 23 have rounded edges. This is illustrated in FIG. 7, where part of the tube 23 is shown. In the embodiment shown in FIG. 6, the end 27 of the tube 23 is provided with a flange or baffle 25. This flange 25 serves to lower the total mechanical resistance Rp of the enclosure. This quantity Rp is the mechanical resistance seen as a lumped parameter at the end 27 of the tube. The transition from the tube 23 to the flange 25 is smooth due to the rounded edge 24.

As noted above, in the preferred embodiments of the present invention substantially no acoustic damping material is present in the enclosure 22 and the associated pipe 23.

In FIG. 8 a graph showing an audio frequency distribution is schematically depicted. The graph 30 indicates the amplitude Amp (vertical axis) of an audio signal at a particular frequency f (horizontal axis). As shown, the audio signal contains virtually no signal components below approximately 10 Hz. As the following discussion will focus on the low-frequency part of the graph 30, the mid- and high-frequency parts of the graph have been omitted for the sake of clarity of the illustration.

In accordance with the present invention, a first frequency range is mapped onto a second, smaller frequency range which is preferably contained in the first frequency range. In the non-limiting example of FIG. 8, a first frequency range I is the range from 20 Hz to 120 Hz, while a second range II is the range around 60 Hz, for example 55-65 Hz. This first range I substantially covers the “low-frequency” part of an audio signal, whereas the second range II of FIG. 8 is chosen so as to correspond with a particular transducer unit, such as a loudspeaker unit, and will depend on the characteristics of the transducer unit. According to an important aspect of the present invention, the second range II preferably corresponds with the frequencies at which the transducer unit is most efficient, resulting in the highest sound production.

It will be understood that the size (bandwidth) of the second range II may also depend on the characteristics of the transducer(s). A transducer or array of transducers having a wider range of frequencies at which it is most efficient (possibly multiple resonance frequencies) will benefit from a wider second range II. Transducers or arrays of transducers having a single most efficient frequency, such as the Helmholtz frequency f_{H}, may benefit from an extremely narrow second range II as this will concentrate all energy in said single frequency.

It is noted that in the example shown the second range II is located within the first range I. This means that the first range I is effectively compressed and that no frequencies outside the first range are affected.

The device 10 according to the present invention which is shown merely by way of non-limiting example in FIG. 9 comprises a band-pass filter 11, a detector 12, an (optional) low-pass filter 13, a multiplier 14 and a generator 15. The filter 11 has a pass-band which corresponds to the first range I, thus eliminating all frequencies outside the first range. The detector 12 detects the signal V_{F} received from the filter 11. The detector 12 preferably is a peak detector known per se, but may also be an envelope detector known per se. In a very economical embodiment, the detector may be constituted by a diode.

The signal V_{E} produced by the detector 12 represents the amplitude of the combined signals present within the first range I (see FIG. 8). Multiplier 14 multiplies this signal by a signal V₀ having a frequency f_{w}. This signal V₀ may be generated by a suitable generator 15. The output signal V_{M} of the multiplier 14 has an average frequency approximately equal to f_{w} while its amplitude is dependant on the signals contained in the first frequency range I. By varying the generator frequency f_{w}, the average frequency and therefore the location of the second audio frequency range II can be varied.

An audio system according to the present invention is schematically illustrated in FIG. 10. A device 1 for driving transducers is shown to comprise a frequency mapping device 10 and a processing unit 19 arranged in parallel. An input signal Vin produced by a sound source 2 is fed to both the device 10 and the processing unit 19. As illustrated in FIG. 9, the frequency mapping device 10 selects a frequency range, for example the bass frequency range, and maps this frequency range onto the Helmholtz frequency of the (schematically represented) first transducer unit 20. The processing unit 19 may comprise an amplifier to amplify all frequencies and feed the resulting signal to the (schematically represented) second transducer unit 29. Additionally, or alternatively, the processing unit 19 may comprise filters for filtering certain frequencies.

In a preferred embodiment, the processing unit 19 comprises delay elements for delaying the signal fed to the second transducer unit 29 in such a way that the sound pressure of the first transducer unit 20 is approximately equal to the sound pressure of the second transducer unit 29, in particular at a certain time instant. In this embodiment, the processing unit 19 introduces delays to equal any delays introduced by the device 10.

The first transducer unit 20 is preferably a transducer unit according to the present invention which is designed to operate at its Helmholtz frequency, while the second transducer unit 29 may be a conventional transducer unit having one or more transducers.

The sound source 2 may be constituted by any suitable sound source, such as a radio tuner, a CD or DVD player, an MP3 or AAC player, an Internet terminal, and/or a computer having suitable audio storage means.

The present invention is based upon the insight that a transducer can produce a maximum amount of sound at a minimum cone displacement when driven at its Helmholtz frequency. The present invention benefits from the further insight that a frequency range can be mapped upon another, narrower frequency range that contains the Helmholtz frequency so as to render the original frequency range with maximum efficiency.

The present invention is not limited to conventional electro-magnetic loudspeakers having a magnet, a coil and a cone, but may also be applied to other audio transducers, such as electrostatic loudspeakers.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims. In this context it is noted that various combinations of features defined in the claims are possible within the scope of the invention. Thus the invention also includes these combinations.

1. A device (1) for driving a transducer unit (20) comprising at least one transducer (21) and an enclosure (22) in which the at least one transducer is accommodated, the device comprising mapping means (10) for mapping input signal components from a first audio frequency range (I) onto a second audio frequency range (II),
wherein the second audio frequency range (II) is narrower than the first audio frequency range (I), and wherein the second frequency range (II) contains the Helmholtz frequency (f_{H}) of the transducer unit (20).

2. The device according to claim 1, wherein the narrow frequency range (II) extends within 5% of the Helmholtz frequency (f_{H}), preferably within 2%.

3. The device according to claim 1, wherein the mapping means (10) comprise:
a detection unit (12) for detecting first signal components in the first audio frequency range (I),
a generator unit (15) for generating second signal components in the second audio frequency range (II), and
amplitude control means (14) for controlling the amplitude of the second signal components in dependence of the amplitude of the first signal components.

4. The device according to claim 1, further comprising a processing unit (19) comprising delay elements for delaying the signal fed to the second transducer unit (29) in such a way that the sound pressure of the first transducer unit (20) is approximately equal to the sound pressure of the second transducer unit (29).

5. A transducer unit (20) for use with the device (1) according to claim 1, the transducer unit comprising at least one transducer (21) and an enclosure (22) in which the at least one transducer is mounted, the enclosure comprising an open-ended tube (23).

6. The transducer unit according to claim 5, wherein the enclosure (22) defines a volume V₁ between the transducer (21) and the tube (23), which volume at least approximately satisfies the equation:
$${V}_{1} = \frac{c \cdot S}{2 π \cdot {f}_{w}} \cdot \frac{1 - η T}{η + T}$$
where c is the sound velocity in air, S is the inner cross-sectional surface of the tube, f_{w} is the central frequency of the second audio frequency range (II), is given by 0.85·2π·f_{w}·r/c, r is the inner radius of the tube, T is given by T=tan(2π·L·f_{w}/c), and L is the length of the tube (23).

7. The transducer unit according to claim 5, wherein the transducer (21) has a force factor BI which at least approximately satisfies the equation:
$$Bl = \sqrt{{R}_{E}} \cdot {\{ \begin{matrix}{[ {R}_{M} + \frac{{( S \cdot ρ \cdot c )}^{2}}{{R}_{p}} \cdot \frac{{( T + η )}^{2}}{{T}^{2} + 1} ]}^{2} + \\ {( 2 π \cdot m \cdot {f}_{0} )}^{2} \cdot {[ \frac{{f}_{H}}{{f}_{0}} - \frac{{f}_{0}}{{f}_{H}} ]}^{2}\end{matrix} \}}^{1 / 4}$$
where R_{E} is the electrical resistance of the transducer, R_{M} is the mechanical resistance of the transducer, S is the effective radiating surface of the transducer, is the density of air, c is the sound velocity in air, T is given by T=tan(2π·L·f_{H}/c), L is the length of the tube (23), is given by η≈0.85·2π·f_{H}/c, m is the moving mass of the transducer, f_{H} is the Helmholtz frequency of the transducer unit, and f₀ is the resonance frequency of the transducer in the absence of an enclosure extending between the transducer and the open air.

8. The transducer unit according to claim 5, wherein the enclosure (22) defines an additional volume V₂, which additional volume is substantially closed off, the volumes V₁ and V₂ preferably being located at opposite sides of the transducer (21).

9. The transducer unit according to claim 5, wherein any edges (24) are substantially rounded.

10. The transducer unit according to claim 5, wherein substantially no damping material is present.

11. The transducer unit according to claim 5, wherein the open end of the tube (23) is provided with a flange (25).

12. The transducer unit according to claim 5, further comprising a device (1) enclosure (22) in which the at least one transducer is accommodated, the device comprising mapping means (10) for mapping input signal components from a first audio frequency range (I) onto a second audio frequency range (II),
wherein the second audio frequency range (II) is narrower than the first audio frequency range (1), and wherein the second frequency range (II) contains the Helmholtz frequency (f_{H}) of the transducer unit (20).

13. An audio system, comprising an audio amplifier, at least one transducer (21, 29) and at least one device (1) according to claim 1, the audio system preferably further comprising a sound source (2).

14. A method of driving a transducer unit (20) comprising at least one transducer (21) accommodated in an enclosure (22) provided with an open-ended tube (23), the method comprising the step of mapping an input signal onto a narrow frequency range (II) containing the Helmholtz frequency (f_{H}) of the transducer unit.

15. The method according to claim 14, wherein the narrow frequency range (II) extends within 5% of the Helmholtz frequency (f_{H}), preferably within 2%.

16. The method according to claim 14, wherein the step of mapping comprises the sub-steps of:
detecting first signal components in the first audio frequency range (I),
generating second signal components in the second audio frequency range (II), and
controlling the amplitude of the second signal components in dependence of the amplitude of the first signal components.

17. A computer program product for carrying out the method according to claim 14.
